(19) United States
(12) Patent Application Publication
(10) Pub. No.: US 2007/0129534 A1
(43) Pub. Date: Jun. 7, 2007

(54) Conjugated copolymer, production method thereof and capacitor using the copolymer

(75) Inventors: Hideki Ohata, Chiba (JP); Yoshihiro Saida, Chiba (JP); Shuichi Naijo, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 10/573,415

(22) PCT Filed: Sep. 24, 2004
(86) PCT No.: PCT/JP04/14444

§ 371 Date: Nov. 20, 2006

Related U.S. Application Data
(60) Provisional application No. 60/508,868, filed on Oct. 7, 2003.

(30) Foreign Application Priority Data
Sep. 25, 2003 (JP) 2003-332653

(51) Int. Cl. C08G 75/00

(52) U.S. Cl. 528/373

(57) ABSTRACT

The present invention relates to a novel π-conjugated copolymer having a high conductivity, obtained through chamically oxidative polymerization of a thiophene-based unit represented by formula (IV) and a pyrrole-based unit represented by formula (III) at a low temperature, preferably in the presence of a compound containing a counter anion, and production method therefor, and further relates to an article coated with the copolymer, a solid electrolytic capacitor using the copolymer as solid electrolyte and production method for the capacitor.

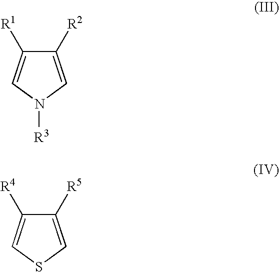

### CROSS-REFERENCE TO RELATED APPLICATIONS

This is an application filed pursuant to 35 U.S.C. Section 111(a) with claiming the benefit of U.S. provisional application Ser. No. 60/508,868 filed Oct. 7, 2003 under the provision of 35 U.S.C. 111(b), pursuant to 35 U.S.C. Section 119(e)(1).

### TECHNICAL FIELD

The present invention relates to a novel π-conjugated copolymer having a high electrical conductivity, a method for producing the same and a capacitor using the same. Further, the invention particularly relates to a novel π-conjugated copolymer suitable for use in the electronics field as electrically conductive materials for electrodes, sensors, electronics display devices, photoelectric conversion devices, antistatic materials, optical materials, various electronic components etc. which are required to have high workability, a method for producing the same, and a capacitor using the same which is excellent in high-frequency property.

### BACKGROUND ART

Various studies and developments have been being made on electrically conductive polymers having conjugated double bonds, as typified by polyanilines, polypyrroles, and polythiophenes. In particular, the electronic, magnetic, and optical properties peculiar to the π-electron conjugated systems which those electrically conductive polymers comprise have been attracting much attention. Typical methods for producing the electrically conductive polymers include chemical oxidative polymerization methods and electrolytic polymerization methods.

In a case where electrolytic polymerization method is employed, a polymer is very densely deposited to form a film, for example, on a platinum electrode in an electrolytic solution, so that the polymer with excellent properties is obtained. However, such an electrolytic polymerization method involves a serious disadvantage in production costs and is unsuitable for mass production.

In a case where chemical oxidative polymerization method is employed, an electrically conductive polymer can be easily obtained by mixing a polymerizable monomer with an appropriate oxidizing agent. For its easiness, chemical oxidative polymerization methods have been attracting industrial attention and have been researched and developed. Developments of electrically conductive polymer material with a high electric conductivity as an alternative to metal-based materials, particularly for use as a solid electrolyte in solid electrolytic capacitors, are being sought.

However, electrically conductive polymers are generally insoluble and infusible to have operational disadvantages. Further, the polymers produced by chemical oxidative polymerization methods are in form of fine particles, which is a disadvantage in that such a polymer cannot be put to immediate use.

With respect to many kinds of electrically conductive polymer material with high electric conductivity heretofore developed, it is known that orientation of the materials can be improved by mechanical procedures such as stretching and drawing to increase the electric conductivity, such stretching methods cannot easily be applied at the micro level. Further, though polymerization regularity of the electrically conductive polymers can be increased by electromagnetic methods using electric or magnetic field, etc., such a method generally requires a special facility in order to be put into industrial use, which is a disadvantage in costs.

To overcome the disadvantages, various attempts have been made on the development of the material.

JP-A-1-313521 (European Patent No.339340) discloses that a certain 3,4-di-substituted polythiophene has a high electrical conductivity and a technique where antistatic property is imparted to a slightly- or non-conductive substrate by applying 3,4-di-substituted polythiophene directly onto the substrate and chemically oxidizing it with a known oxidizing agent. However, homopolymerization of the 3,4-di-substituted polythiophene proceeds at a low polymerization rate, and the electrical conductivity of the product is insufficient.

It is disclosed in JP-A-9-268258 (related patent: U.S. Pat. No. 5,895,606 Specification ) that, in chemical polymerization for producing an electrically conductive composition containing a polymer with a conjugated double bond as a main component where fine oxide particles are compounded, polymerizable monomers are adsorbed onto surface of the insoluble components, to thereby produce the polymer of a thin layer with a high structure regularity easily and suggests that the thin layer polymer produced thereby can have improved properties. However, the fine oxide particles are added as a third component and remain in the electrically conductive composition even after washing, and therefore, though the particles contribute to improvement in the performances of the thin layer, they cause deterioration of the electrical conductivity of the entire composition, resulting in reduction of the performances of the bulk.

JP-A-11-292957 discloses a method for producing electrically conductive fine particles, comprising a step of oxidation-polymerizing an electrically conductive monomer of a 5-membered heterocyclic compound in the presence of another 5-membered heterocyclic compound to obtain electrically conductive fine particles having various particle diameters and electrical conductivity stable to environmental variation. In this document, although a preferred compound has a long-chain ethyleneoxy group in a side chain, polymerization acceleration due to use of a pyrrole compound in the present invention is not mentioned, and the method cannot achieve a sufficient electrical conductivity.

JP-A-3-7715 discloses a polymerization method comprising an oxygen-induced oxidation coupling polymerization under mild conditions, wherein an aromatic derivative selected from a benzene derivative, a pyrrole derivative, and a thiophene derivative is polymerized using a catalyst in the presence of an acid under ordinary temperature and pressure. In this method, the polymerization requires several tens of hours in an embodiment, and it is suggested that high oxygen partial pressure is needed to reduce the reaction time. Further, a specific metal complex is used, and the method requires steps of removing water from organic solvents and of adding an acidic component.

JP-A-2-98915 discloses a technique comprising polymerizing two or more types of monomers to prepare a polymer compound and doping the polymer compound with a dopant to obtain an electrically conductive polymer compound for use as a solid electrolyte. However, production conditions for the chemical oxidative polymerization are not described in detail.

JP-A-2000-188238 discloses a technique where a conductive polymer layer comprising poly(3,4-ethylenedioxythiophene) layer and polypyrrole compounded therein is formed by applying a mixed solution of 3,4-ethylenedioxythiophene monomer and an oxidizing agent dissolved in a solvent to thereby form a poly(3,4-ethylenedioxythiophene) layer through polymerization reaction between the 3,4-ethylenedioxythiophen monomer and the oxidizing agent, then allowing a pyrrole monomer solution to contact the poly(3,4-ethylenedioxythiophene) layer, thereby causing the oxidizing agent contained in the poly(3,4-ethylenedioxythiophene) layer to be dissolved into the pyrrole monomer solution and at the same time a chemical polymerization reaction of the pyrrole monomer with the oxidizing agent dissolved in the monomer to proceed. In this technique, polymerization of 3,4-ethylenedioxythiophene and polymerization of pyrrole are not carried out in the same step, and moreover the formation of a layer from 3,4-ethylenedioxythiophene is carried out separately from the step of compounding polypyrrole. Accordingly, the technique, which does not involve a compounding process in the molecular level, is different from the present invention.

### DISCLOSURE OF THE INVENTION

An object of the present invention is to provide a thiophene-based π-conjugated copolymer having a high electrical conductivity, a method capable of producing the π-conjugated copolymer under mild conditions, a capacitor and the like using the obtained π-conjugated copolymer as a solid electrolyte.

The inventors have found that polymerization of a thiophene-based compound can be accelerated in the presence of a pyrrole-based compound to produce a π-conjugated copolymer with the pyrrole-based compound, and that the electrical conductivity of the π-conjugated copolymer can be made higher by doping. The present invention has been accomplished based on the findings.

Thus, the invention relates to a π-conjugated copolymer, a method for producing the copolymer, an article coated with the copolymer, a solid electrolytic capacitor using the copolymer as a solid electrolyte and production method therefor as follows.

1. A π-conjugated copolymer comprising a pyrrole-based unit and a thiophene-based unit represented by the general formula (I): 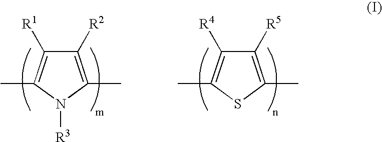
wherein R¹, R², R⁴, and R⁵ independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R¹ and R², and R⁴ and R⁵ may be bonded together at any positions respectively to form at least one 3 to 7-membered, saturated or unsaturated, hydrocarbon ring structure, the ring structure may arbitrarily contain a carbonyl bond, an ether bond, an ester bond, an amide bond, a sulfide bond, a sulfinyl bond, a sulfonyl bond, and an imino bond, the hydrocarbon forming the ring structure may have a group selected from the group consisting of linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R³ represents a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10carbon atoms, halogen atom, nitro group, cyano group, primary, secondary or tertiary amino group, trihalomethyl group and phenyl group which may have a substituent, and m and n represent a composition ratio of the π-conjugated copolymer and satisfy the conditions of m+n=1 and 0<m≦0.75.

2. A π-conjugated copolymer comprising a pyrrole-based unit and a thiophene-based unit represented by the general formula (II), and an electrochemically and/or chemically doped structure: 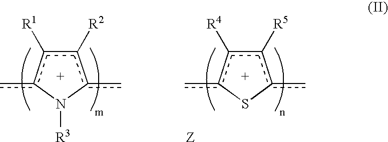
wherein R¹, R², R⁴, and R⁵ independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R¹ and R², and R⁴ and R⁵ may be bonded together at any positions respectively to form at least one 3 to 7-membered, saturated or unsaturated, hydrocarbon ring structure, the ring structure may arbitrarily contain a carbonyl bond, an ether bond, an ester bond, an amide bond, a sulfide bond, a sulfinyl bond, a sulfonyl bond, and an imino bond, the hydrocarbon forming the ring structure may have a group selected from the group consisting of linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R³ represents a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, m and n represent a composition ratio of the π-conjugated copolymer and satisfy the conditions of m+n=1 and 0<m≦0.75, and Z represents a counter anion with dopability.

3. The π-conjugated copolymer according to 1 above, wherein the pyrrole-based unit is such that R¹ and R² in the general formula (I) independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atoms and cyano group, alternatively R¹ and R² are bonded together at any positions to form a 3 to 7-membered, saturated or unsaturated, hydrocarbon ring structure that may contain an ether bond and/or a sulfonyl bond, and R³ represents a hydrogen atom.

4. The π-conjugated copolymer according to 3 above, wherein the pyrrole-based unit is pyrrole.

5. The π-conjugated copolymer having the electrochemically and/or chemically doped structure according to 2 above, wherein the pyrrole-based unit is such that R¹ and R² in the general formula (II) independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom and a cyano group, alternatively, R¹ and R² are bonded together at any positions to form a 3 to 7-membered, saturated or unsaturated, hydrocarbon ring structure that may contain an ether bond and/or a sulfonyl bond, and R³ represents a hydrogen atom.

6. The π-conjugated copolymer according to 5 above, wherein the pyrrole-based unit is pyrrole.

7. The π-conjugated copolymer according to 1 above, wherein the thiophene-based unit is such that R⁴ and R⁵ in the general formula (I) independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom and cyano group, alternatively, R⁴ and R⁵ are bonded together at any positions to form a 3 to 7-membered, saturated or unsaturated, hydrocarbon ring structure that may contain an ether bond and/or a sulfonyl bond.

8. The π-conjugated copolymer according to 7 above, wherein the thiophene-based unit is 3,4-ethylenedioxythiophene.

9. The π-conjugated copolymer having the electrochemically and/or chemically doped structure according to 2 above, wherein the thiophene-based unit is such that R⁴ and R⁵ in the general formula (II) independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom and cyano group, alternatively R⁴ and R⁵ are bonded together at any positions to form a 3 to 7-membered, saturated or unsaturated, hydrocarbon ring structure that may contain an ether bond and/or a sulfonyl bond.

10. The π-conjugated copolymer according to 9 above, wherein the thiophene-based unit is 3,4-ethylenedioxythiophene.

11. The π-conjugated copolymer according to any one of 2, 5, 6, 9 and 10 above, having an electric conductivity of 5 S/cm or more.

12. A method for producing a c-conjugated copolymer of 1 or 2 above, comprising copolymerizing a pyrrole-based compound represented by the general formula (III): 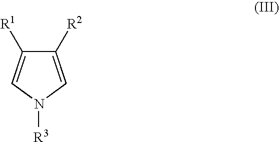
(in the formula, R¹ to R³ have the same meanings as defined in 1 above)
and a thiophene-based compound represented by the general formula (IV) 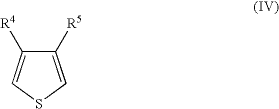
(in the formula, R⁴ and R⁵ have the same meanings as defined in 1 above)
by performing chemical oxidative polymerization in the presence of an oxidizing agent at a polymerization temperature of 60° C. or lower.

13. The method for producing a π-conjugated copolymer according to 12 above, wherein the polymerization is carried out in the presence of a compound containing a counter anion with dopability.

14. The method for producing a π-conjugated copolymer according to 12 or 13 above, wherein the pyrrole-based compound is pyrrole.

15. The method for producing a π-conjugated copolymer according to 12 or 13 above, wherein the thiophene-based compound is 3,4-ethylenedioxythiophene.

16. The method for producing a π-conjugated copolymer according to 12 or 13 above, wherein the oxidizing agent contains an iron salt or a persulfate salt.

17. The method for producing a π-conjugated copolymer according to 13 above, wherein the compound containing a counter anion with dopability is an organic sulfonic acid compound.

18. The method for producing a π-conjugated copolymer according to 12 or 13 above, wherein a mixed solvent of isopropanol and water is used in the polymerization.

19. The method for producing a π-conjugated copolymer according to 12 or 13 above, wherein the polymerization temperature is 30° C. or lower.

20. An article comprising an oxide film formed by electrolytically oxidizing a valve action metal, wherein the oxide film is coated with the π-conjugated copolymer described in any one of 1 to 11 above.

21. The article according to 20 above, wherein the valve action metal comprises at least one metal selected from the group consisting of aluminum, silicon, tantalum, niobium, titanium and zirconium.

22. A solid electrolytic capacitor, comprising as a solid electrolyte the π-conjugated copolymer described in any one of 1 to 11 above.

23. A method for producing a solid electrolytic capacitor in which a solid electrolyte layer comprising a π-conjugated copolymer is formed on a dielectric film of porous valve-action metal, which method comprises a step of polymerizing a pyrrole-based compound represented by the general formula (III): 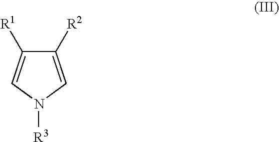
(in the formula, R¹ to R³ have the same meanings as defined in 1 above)
and a thiophene-based compound represented by the general formula (IV): 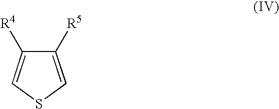
(in the formula, R⁴ and R⁵ have the same meanings as defined in 1 above)
by using a solution of an oxidizing agent having polymerization-initiating property singly or using a mixed solution of such an oxidizing agent and an electrolyte which contains a counter anion with dopability to form the π-conjugated copolymer on the dielectric film.

24. The method for producing a solid electrolytic capacitor according to 23 above, wherein the polymerization is carried out within a temperature range of −30° C. to 40° C.

25. The method for producing a solid electrolytic capacitor according to 23 above, wherein the polymerization is carried out in the atmosphere of a relative humidity of 5% to 70%.

26. The method for producing a solid electrolytic capacitor according to 23 above, wherein the porous valve action metal contains at least one metal selected from the group consisting of aluminum, silicon, tantalum, niobium, titanium and zirconium.

27. The method for producing a solid electrolytic capacitor according to 23 above, comprising using pyrrole-based compound as represented by the general formula (III): 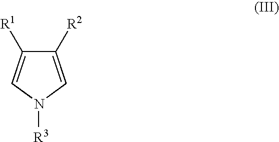
(in the formula, R¹ to R³ have the same meanings as defined in 3 above)
and using thiophene-based compound as represented by the general formula (IV): 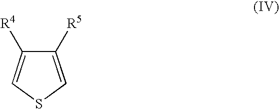
(in the formula, R⁴ and R⁵ have the same meanings as defined in 7 above)

28. The method for producing a solid electrolytic capacitor according to 23 above, wherein the pyrrole-based compound is pyrrole and the thiophene-based compound is 3,4-ethylenedioxythiophene.

29. The method for producing a solid electrolytic capacitor according to 23 above, wherein the oxidizing agent having a polymerization-initiating property contains an iron salt or a persulfate salt.

30. The method for producing a solid electrolytic capacitor according to 23 above, wherein the electrolyte containing a counter anion with dopability contains an organic sulfonic acid compound.

31. The method for producing a solid electrolytic capacitor according to 23 above, wherein the polymerization step is carried out multiple times.

32. The method for producing a solid electrolytic capacitor according to 23 above, wherein the maximum thickness of the solid electrolyte layer formed on the dielectric film is 10 μm to 200 μm.

### DETAILED DESCRIPTION OF THE INVENTION

The present invention is hereinbelow described in more detail.

The copolymer of the invention is an electrically conductive copolymer comprising structures of a pyrrole-based unit and a thiophene-based unit as repeating units represented by formula (I).

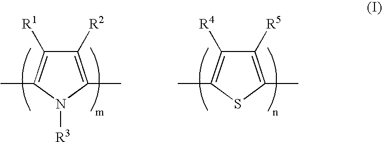

The copolymer can be produced by copolymerization in the presence of an oxidizing agent, using the pyrrole-based compound represented by the general formula (III) and the thiophene-based compound represented by the general formula (IV) as monomers, and the pyrrole-based compound and the thiophene-based compound each form the units in the copolymer. 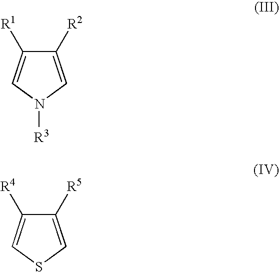
(In the formula, R¹, R^{2,} R⁴, and R⁵ independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R¹ and R², and R⁴ and R⁵ may be bonded together at any positions respectively to form at least one 3 to 7-membered, saturated or unsaturated, hydrocarbon ring structure, the ring structure may arbitrarily contain a carbonyl bond, an ether bond, an ester bond, an amide bond, a sulfide bond, a sulfinyl bond, a sulfonyl bond and an imino bond, the hydrocarbon forming the ring structure may have a group selected from the group consisting of linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, and R³ represents a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent.)

The π-conjugated copolymer of the present invention may also be a π-conjugated copolymer comprising a pyrrole-based unit and a thiophene-based unit as repeating units represented by general formula (II) below and having a structure electrochemically and/or chemically doped. The copolymer is prepared by a process where a π-conjugated copolymer represented by formula (I) is electrochemically and/or chemically doped, positive charges of cation-radicals or cations which arise from the doping process are electrically neutralized with counter anions with dopability, and upon applying an electric field, the electric-charges become movable. 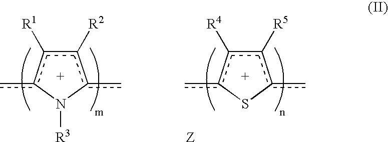
(In the formula, R¹, R², R⁴, and R⁵ independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R¹ and R², and R⁴ and R⁵ may be bonded together at any positions respectively to form at least one 3 to 7-membered, saturated or unsaturated, hydrocarbon ring structure, the ring structure may arbitrarily contain a carbonyl bond, an ether bond, an ester bond, an amide bond, a sulfide bond, a sulfinyl bond, a sulfonyl bond, and an imino bond, the hydrocarbon forming the ring structure may have a group selected from the group consisting of linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R³ represents a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, m and n represent a composition ratio of the π-conjugated copolymer and satisfy the conditions of m+n=1 and 0<m≦0.75, and Z represents a counter anion with dopability.)

Examples of the pyrrole-based compounds used as a starting material for the π-conjugated copolymer include pyrrole and derivatives thereof such as 3-methylpyrrole, 3-ethylpyrrole, 3-propylpyrrole, 3-butylpyrrole, 3-pentylpyrrole, 3-hexylpyrrole, 3-heptylpyrrole, 3-octylpyrrole, 3-nonylpyrrole, 3-decylpyrrole, 3-fluoropyrrole, 3-chloropyrrole, 3-bromopyrrole, 3-cyanopyrrole, 3,4-dimethylpyrrole, 3,4-diethylpyrrole, 3,4-butylenepyrrole, 3,4-methylenedioxypyrrole and 3,4-ethylenedioxypyrrole. These compounds may be commercial products and may be prepared by known methods, and the invention is not limited thereto.

Examples of the thiophene-based compounds include thiophene and derivatives thereof such as 3-methylthiophene, 3-ethylthiophene, 3-propylthiophene, 3-butylthiophene, 3-pentylthiophene, 3-hexylthiophene, 3-heptylthiophene, 3-octylthiophene, 3-nonylthiophene, 3-decylthiophene, 3-fluorothiophene, 3-chlorothiophene, 3-bromothiophene, 3-cyanothiophene, 3,4-dimethylthiophene, 3,4-diethylthiophene, 3,4-butylenethiophene, 3,4-methylenedioxythiophene and 3,4-ethylenedioxythiophene.

These thiophene-based compounds may be commercial products and may be prepared by known methods (see, for example, Synthetic Metals, 1986, Vol. 15, Page 169), and the invention is not limited thereto. Further examples of the thiophene-based compounds include compounds having a skeleton of 1,3-dihydro-polycyclic-sulfide (also known as 1,3-dihydrobenzo[c]thiophene), compounds having a skeleton of 1,3-dihydronaphtho [2,3-c]thiophene, compounds having a skeleton of 1,3-dihydroanthra[2,3-c]thiophene, and compounds having a skeleton of 1,3-dihydronaphthaceno[2,3-c]thiophene. These compounds may be prepared by known methods described in JP-A-8-3156, etc. The thiophene-based compound may contain nitrogen or N-oxide in the condensed ring, and the examples thereof include 1,3-dihydrothieno[3,4-b]quinoxaline, 1,3-dihydrothieno[3,4-b]quinoxaline-4-oxide and 1,3-dihydrothieno[3,4-b]quinoxaline-4,9-dioxide.

Further, two or more of the above compounds may be used in combination to obtain a 3- or multi-component copolymer.

Useful examples of linear or branched, saturated or unsaturated alkyl group having 1 to 10 carbon atoms used in the present invention include methyl group, ethyl group, propyl group, isopropyl group, butyl group, t-butyl group, pentyl group, hexyl group, octyl group, vinyl group, allyl group, 1-butenyl group, 3-butenyl group and 5-hexenyl group. Useful examples of linear or branched, saturated or unsaturated alkoxy group having 1 to 10 carbon atoms used in the present invention include methoxy group, ethoxy group, propoxy group, isopropoxy group, butoxy group, pentoxy group, hexyloxy group and octyloxy group. Useful examples of linear or branched, saturated or unsaturated alkyl ester group having 1 to 10 carbon atoms used in the present invention include methyl ester group, ethyl ester group, propyl ester group, isopropyl ester group, butyl ester group, pentyl ester group, hexyl ester group and octyl ester group. However, the present invention is not limited to these examples.

Examples of halogen atom used in the present invention include chlorine, bromine and fluorine. Examples of primary, secondary or tertiary amino group used in the present invention include methyl amino group, ethyl amino group, propyl amino group, butyl amino group, pentyl amino group, hexyl amino group and dimethyl amino group. Examples of trihalomethyl group used in the present invention include trichloromethyl group, tribromomethyl group and trifluoromethyl group. Examples of phenyl group which may have a substituent used in the present invention include phenyl group which is substituted by halogen atom such as chrorine, bromine and fluorine, tolyl group and biphenyl group.

In the method for producing the π-conjugated copolymer of the invention, the pyrrole-based compound acts to accelerate the polymerization of the thiophene-based compound. Also the pyrrole-based compound itself may form a π-conjugated system in the π-conjugated copolymer together with or separately from other monomers. As pyrrole-based compound, a compound having a property of further increasing the electric conductivity of the π-conjugated copolymer is preferably used. Specifically, such a pyrrole-based compound has a higher polymerization activity with the oxidizing agent than the thiophene-based compound does, and more specifically the pyrrole-based compound helps and accelerates the polymerization of the thiophene-based compound even under conditions where the thiophene-based compound cannot be polymerized independently.

It is preferable that the thiophene-based compound have an oxidation potential between the reduction potential of the oxidizing agent and the oxidation potential of the pyrrole-based compound. It is because the thiophene-based compound is assumed to express its activities even under the inactive polymerization conditions by a process where the pyrrole-based compound is oxidized by the polymerization-oxidizing agent and becomes a polymerization initiator and is reacted with the thiophene-based compound.

In the present invention, the composition ratio of the π-conjugated copolymer is to be determined depending on kinds of pyrrole compound and thiophene compound used and reaction conditions, particularly on the polymerization time and the presence or absence of an extra dopant added in the reaction. The composition ratio is preferably 0<m<0.8, and more preferably 0.01<m≦0.75. When the composition ratio of the obtained π-conjugated copolymer is m≧0.8, the electric conductivity is lowered, and when the ratio is in a range of 0.75<m<0.8, the electric conductivity of the obtained π-conjugated copolymer is particularly susceptible to the reaction condition. Thus, a slight difference in the composition ratio affects the electrical conductivity.

The oxidizing agent used in the invention may be any agent capable of sufficiently promoting a dehydrogenating 2-electron oxidation reaction or a dehydrogenating 4-electron oxidation reaction. The oxidizing agent is preferably a compound low in industrial costs and easy to handle in the method. Specific examples of the oxidizing agents include iron salts such as FeCl₃, FeClO₄ and Fe salts of organic acid anions; anhydrous aluminum chloride/copper (I) chloride; alkaline metal persulfates; ammonium persulfates; peroxides; manganese compounds such as potassium permanganate; quinone compounds such as 2,3-dichloro-5,6-dicyano-1,4-benzoquinone (DDQ), tetrachloro-1,4-benzoquinone, and tetracyano-1,4-benzoquinone; halogens such as iodine and bromine; peracids; sulfonic acid compounds such as sulfuric acid, fuming sulfuric acid, sulfur trioxide, chlorosulfuric acid, fluorosulfuric acid, and amidosulfuric acid; ozone; and combinations thereof.

Preferred oxidizing agents include iron salts, copper (I) chloride-based compounds, alkali persulfates, ammonium persulfates, manganic acid compounds, and quinone compounds. Particularly preferred among them are iron salts, and ammonium persulfates which contain a smaller amount of various impurities.

In the method for producing the π-conjugated copolymer according to the present invention, a counter anion with dopability which is optionally added maybe an electrolyte having as a counter ion the anion derived from the oxidizing agent (reductant of the oxidizing agent) or the other anionic electrolyte. Specific examples of the counter anions include halogenated 5B group element anions such as PF₆⁻, SbF₆⁻ and AsF₆⁻; halogenated 3B group element anions such as BF₄⁻; halogen anions such as I⁻ (I₃⁻), Br⁻, and Cl⁻; halogen acid anions such as ClO₄⁻; Lewis acid anions such as AlCl₄⁻, FeCl₄⁻, and SnCl₅⁻; inorganic acid anions such as NO₃⁻ and SO₄²⁻; organic sulfonic acid anions such as p-toluenesulfonic acid anion, naphthalenesulfonic acid anion, alkyl-substituted sulfonic acid anions having 1 to 5 carbon atoms, CH₃SO₃⁻ and CF₃SO₃⁻; and protonic acid anions including carboxylic acid anions such as CF₃COO⁻ and C₆H₅COO⁻. The specific examples further include anions of polymer electrolytes such as polyacrylic acid, polymethacrylic acid, polystyrene sulfonic acid, polyvinylsulfonic acid, polyvinylsulfuric acid, poly-α-methylsulfonic acid, polyethylene sulfonic acid and polyphosphoric acid. However, the invention is not limited to these examples.

High or low molecular organic sulfonic acid compounds and polyphosphoric acid are preferred, and aryl sulfonic acid salts are more preferred as the dopant. For example, the aryl sulfonic acid salt dopants include salts of benzenesulfonic acid, toluenesulfonic acid, naphthalenesulfonic acid, anthracenesulfonic acid, anthraquinonesulfonic acid, derivatives thereof, etc.

By selecting and adding an appropriate dopant, the shape of the obtained π-conjugated copolymer can be converted into spherical or aciculate shape.

In the present invention, monomer concentration may be selected depending on type of substituents in the compound and type of solvent used. In general, the monomer concentration is preferably 10⁻³ to 10 mol/L, more preferably 10⁻² to 5 mol/L.

The charging ratio of the pyrrole compound at the time of starting the reaction in the present invention depends on the kind and the reaction condition and are not particularly limited. Provided that the total of molar concentrations of the pyrrole compound and the thiophene compound is 1, the compounding ratio of the pyrrole compound is preferably 0.5 or less, and more preferably 0.3 or less. When the charging ratio of the pyrrole compound exceeds 0.5, the reaction of the pyrrole compound dominantly proceeds, and particularly in a case where the reaction time is long, the electric conductivity is adversely affected. In order to enhance the electric conductivity, it is preferable that the polymerization be carried out in a shorter period of time with addition of an extra dopant.

The reaction temperature depends on the reaction method and is not particularly restricted. The reaction temperature is generally −70 to 60° C., preferably −30 to 50° C., more preferably −10 to 40° C. When the reaction is carried out at a temperature lower than −70° C., the polymerization rate decreases, which leads to practical problems in relation to reaction equipment and productivity. At a polymerization temperature higher than 60° C., an undesirable reaction forming a structure without the π-conjugated system is promoted and the resultant π-conjugated copolymer is poor in the electric conductivity.

Solvent used for the reaction in the present invention may be any solvent as long as one or more of the monomers, the oxidizing agent and the counter anion with the dopability can be dissolved therein independently or together. Examples of the solvents include ethers such as tetrahydrofuran, dioxane, and diethylether; aprotic polar solvents such as dimethylformamide, acetonitrile, benzonitrile, N-methylpyrrolidone and dimethylsulfoxide; esters such as ethyl acetate and butyl acetate; nonaromatic chlorine-based solvents such as chloroform and methylene chloride; nitro compounds such as nitromethane, nitroethane and nitrobenzene; alcohols such as methanol, ethanol, propanol and isopropanol; organic acids such as formic acid, acetic acid and propionic acid; acid anhydrides of the organic acids, such as acetic anhydride; water; ketones; and mixed solvents thereof. Particularly, the reaction solvent is preferably a mixed solvent of water and an alcohol, more preferably a mixed solvent of water and isopropanol. The oxidizing agent and/or the counter anion with the dopability and the monomers may be dissolved in different solvents respectively, and thus may be used in a two- or three-solvent system.

Thus produced solid electric conductor has an electric conductivity of 1 S/cm or more. An electric conductivity of 3 S/cm or more can be achieved under preferable conditions, and an electric conductivity of 5 S/cm or more can be achieved under more preferable conditions.

Examples of article having an oxide film which is obtained through electrolytic oxidation of valve-action metal include foil obtained by drawing and stretching a valve-action metal and sintered body obtained by sintering fine particles of a valve-action metal. The article employed in the present invention may be subjected to treatment such as etching treatment for enlarging the surface area.

As an oxide film which is obtained through electrolytic oxidation of valve-action metal, an oxide containing at least one selected from the group consisting of aluminum, tantalum, niobium, titanium and zirconium is used, and more specifically, aluminum oxide, silicon, tantalum oxide, niobium oxide, niobium alloy, niobium monoxide and niobium nitride are preferably used.

The π-conjugated copolymer is particularly preferably used as a solid electrolyte for a capacitor having an oxide film formed by electrolytically oxidizing a valve action metal.

A method for producing a solid electrolytic capacitor according to the present invention comprises a step of polymerizing a pyrrole compound represented by formula (III) and a thiophene compound represented by formula (IV): 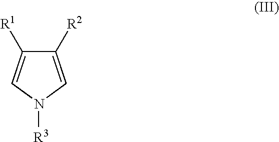
(in the formula, R¹ to R³ have the same meaning as defined above) 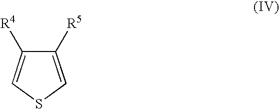
(in the formula, R⁴and R⁵ have the same meaning as defined above) by using a solution of an oxidizing agent having polymerization-initiating property singly or using a mixed solution of the oxidizing agent and an electrolyte containing a counter anion with dopability to form a π-conjugated copolymer on the dielectric film.

In a basic process for polymerizing the pyrrole compound and the thiophene compound by using a solution of an oxidizing agent having polymerization-initiating property singly or using a mixed solution of the oxidizing agent and an electrolyte containing a counter anion with dopability, a solution is prepared by using the pyrrole compound and the thiophene compound only or dissolving the compounds in a solvent, a porous article having a dielectric film is impregnated with the solution to introduce the pyrrole compound and the thiophene compound into the inside of the porous article, and then by further impregnating the article with a solution of an oxidizing agent having polymerization-initiating property singly or a mixed solution of the oxidizing agent and an electrolyte containing a counter anion with dopability, polymerization can be started.

Although the temperature at the time of forming a π-conjugated copolymer as a solid electrolyte on the dielectric film depends on the kinds of the pyrrole compound, the thiophene compound, the solvent, the oxidizing agent and the reaction manner employed and is not particularly limited, the temperature may be within a range where polymerization of the pyrrole compound can be accelerated. Generally, the temperature is preferably −30 to 60° C., more preferably −10 to 40° C. When the temperature is lower than −30° C., polymerization reaction rate decreases, which is practically disadvantageous. When the temperature is higher than 60° C., the structure of the obtained π-conjugated copolymer is adversely affected, which leads to decrease in the electric conductivity.

In forming a π-conjugated copolymer as a sol:id electrolyte on the dielectric film, the relative humidity is an important factor. The relative humidity is preferably within a range of 5 to 70%, andmorepreferably 20 to 50%. When the relative humidity is less than 5%, polymerization reaction on a foil does not proceed sufficiently, which leads to a practical disadvantage that the yield of the π-conjugated copolymer is decreased. When the relative humidity exceeds 70%, polymerization reaction can proceed while the property as a solid electrolytic capacitor deteriorates in microscopic regions inside the porous article, which leads to lowering the electrical conductivity.

In forming a π-conjugated copolymer as a solid electrolyte on the dielectric film, the amount of π-conjugated copolymer is sometimes insufficient when the copolymer is obtained by conducting only once a process comprising a step of impregnating a porous article having a dielectric film thereon with a solution of the pyrrole compound and the thiophene compound alone or a solution of the pyrrole compound and the thiophene compound dissolved in a solvent to thereby introduce the pyrrole compound and the thiophene compound into the inside the porous article, and a subsequent step of impregnating the porous article with a solution of an oxidizing agent having polymerization initiating property singly or a mixed solution of the oxidizing agent and an electrolyte containing a counter anion with dopability.

Therefore, it is preferable that the step of obtaining the copolymer through polymerization using the solution of an oxidizing agent having polymerization-initiating property singly or the mixed solution of the oxidizing agent and an electrolyte containing a counter anion with dopability and then optionally washing be repeated at least three times, practically at least 5 or more times in order to further deposit copolymer obtained in each time. However, it is not preferable that the obtained solid electrolyte be thicker than necessary, and the number of times for repeating the step to obtain a sufficient copolymer is generally 5 to 30. Preferably, a copolymer layer as desired can be obtained by repeating the step 7 to 25 times.

For example, in a case where a π-conjugated copolymer is formed on an etched aluminum foil having a thickness of 100 μm, the thickness value of the solid electrolyte obtained by subtracting the thickness of the foil per se from the entire thickness of the foil after forming the copolymer thereon is preferably 10 μm to 200 μm, more preferably 20 μm to 180 μm. When the thickness is less than 10 μm, the leakage current characteristics deteriorates. When the thickness exceeds 200 μm, the electric properties are adversely affected.

For the purpose of improving electrical contact with a cathode lead terminal, it is preferable to form a conductive layer on thus prepared solid electrolyte of π-conjugated copolymer. For example, conductive paste, plating, metal deposition or a conductive resin film is employed for forming such a conductive layer. Subsequently, a cathode lead terminal is connected and the entirety is jacketed by using resin molding, resin casing, metal casing, resin dipping or the like to thereby prepare a solid electrolytic capacitor for various uses.

### BRIEF DESCRIPTION OF DRAWINGS

FIG. 1 shows a electron microscopic picture of the compound obtained in Example 1 containing 3,4-ethylenedioxythiophene:pyrrole at a composition ratio of 7:3.

FIG. 2 shows a electron microscopic picture of the compound obtained in Example 4 containing 3,4-ethylenedioxythiophene:pyrrole at a composition ratio of 9:1 and further containing a counter anion with dopability.

FIG. 3 shows a electron microscopic picture of the compound obtained in Example 12 containing 3,4-ethylenedioxythiophene:pyrrole at a composition ratio of 7:3 and further containing a counter anion with dopability.

### BEST MODE FOR CARRYING OUT THE INVENTION

The present invention will be explained below in more details with reference to Examples without intention of restricting the scope of the invention.

The ratio indicated in the title line of each Example and Comparative Example is not the ratio of the obtained compound but the charging ratio in starting the reaction.

### EXAMPLE 1

### 3,4-Ethylenedioxythiophene:Pyrrole=9:1

1.70 g of ammonium persulfate was weighed and charged into a 30 ml three-neck round bottom flask, 5.0 ml of water was added thereto, and the resulting solution was cooled to 0° C. while stirring in an ice bath. A sample tube was prepared, 0. 03 g of pyrrole and 0.48 g of 3,4-ethylenedioxythiophene were weighed and charged into the tube, 1.3 ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure, then the mass was measured, to thereby obtain 0.26 g of a copolymer. Then, the copolymer was formed by a forming apparatus into a pellet having a radius of 1 cm. The surface resistance of the pellet was measured by a four-probe method using Loresta IP MCP-250 (produced by Mitsubishi Petrochemical Co., Ltd.). The resistance value was converted into an electric conductivity by multiplying the value by film thickness of the pellet, and the obtained electric conductivity value was 6.8 S/cm.

### EXAMPLE 2

### 3,4-Ethylenedioxythiophene:Pyrrole=7:3

1.91 g of ammonium persulfate was weighed and charged into a 30 ml three-neck round bottom flask, 5.6 ml of water was added thereto, and the resulting solution was cooled to 0° C. while stirring in an ice bath. A sample tube was prepared, 0.09 g of pyrrole and 0.42 g of 3,4-ethylenedioxythiophene were weighed and charged into the tube, 1.4 ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0.49 g of a copolymer. Then, the copolymer was formed by a forming apparatus into a pellet having a radius of 1 cm. The surface resistance of the pellet was measured by a four-probe method using Loresta IP MCP-250 (produced by Mitsubishi Petrochemical Co., Ltd.), and converted into an electric conductivity by multiplying the value by film thickness of the pellet. As a result, the electric conductivity was 12.1 S/cm.

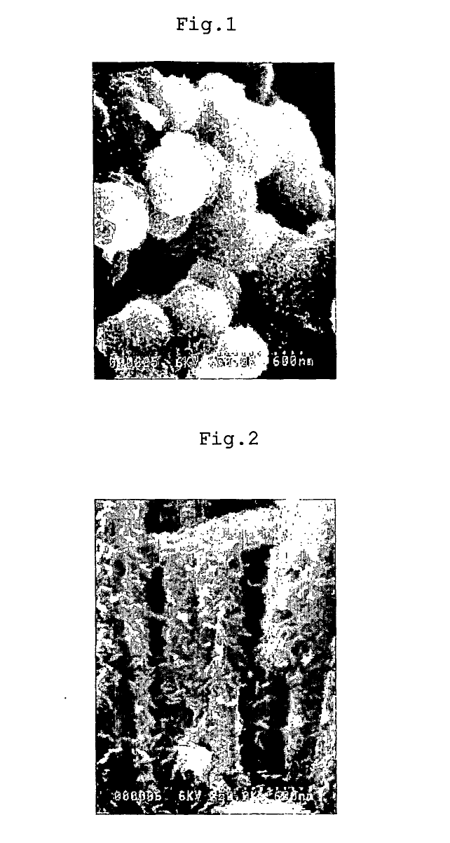

The obtained copolymer was observed by scanning electron microscope (SEM), S-900, manufactured by Hitachi High-Technologies Corporation, at a magnification of 50,000 times and an accelerating voltage of 6 kV. The obtained image is shown in FIG. 1.

### EXAMPLE 3

### 3,4-Ethylenedioxythiophene:Pyrrole=5:5

2.18 g of ammonium persulfate was weighed and charged into a 30 ml three-neck round bottom flask, 6.4 ml of water was added thereto, and the resulting solution was cooled to 0° C. while stirring in an ice bath. A sample tube was prepared, 0.16 g of pyrrole and 0.34 g of 3,4-ethylenedioxythiophene were weighed and charged into the tube, 1.6 ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0.53 g of a copolymer. Then, the copolymer was formed by a forming apparatus into a pellet having a radius of 1 cm. The surface resistance of the pellet was measured by a four-probe method using Loresta IP MCP-250 (produced by Mitsubishi Petrochemical Co., Ltd.) The resistance value was converted into an electric conductivity by multiplying the value by film thickness of the pellet, and the obtained electric conductivity value was 9.4 S/cm.

### EXAMPLE 4

### 3,4-Ethylenedioxythiophene:Pyrrole=9:1+Compound Containing Counter Anion with Dopability

1.70 g of ammonium persulfate and 0.36 g of sodium 2-anthraquinone sulfonate were added into a 30 ml three-neck round bottom flask, 5.0 ml of water was added thereto, and the resulting solution was cooled to 0° C. while stirring in an ice bath. A sample tube was prepared, 0.03 g of pyrrole and 0.48 g of 3,4-ethylenedioxythiophene were weighed and charged into the tube, 1.3 ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0.26 g of a copolymer. Then, the copolymer was formed by a forming apparatus into a pellet having a radius of 1 cm. The surface resistance of the pellet was measured by a four-probe method using Loresta IP MCP-250 (produced by Mitsubishi Petrochemical Co., Ltd.). The resistance value was converted into an electric conductivity by multiplying the value by film thickness of the pellet, and the obtained electric conductivity value was 47 S/cm.

The obtained copolymer was observed by scanning electron microscope (SEM), S-900, manufactured by Hitachi High-Technologies Corporation, at a magnification of 50000 times and an accelerating voltage of 6 kV. The obtained image is shown in FIG. 2.

### EXAMPLE 5

### Production of Capacitor

An etched and formed aluminum foil (4 Voltage formed foil) was cut to a size of 3.3 mm×10 mm, a polyimide solution was applied onto the both surfaces of the aluminum foil into 1-mm-width coatings such that each surface was divided into a 4 mm long portion and a 5 mm long portion in the middle of 10 mm long portion, and the applied solution was dried to form a separator for separating an anode portion and a cathode portion. The 3.3 mm×4 mm portion of the aluminum foil was dipped in a 1.5 mol/L aqueous ammonium persulfate solution (hereinafter referred to as a solution 1), pulled out from the solution, and dried at the room temperature for 3 minutes. Then, the 3.3 mm×4 mm portion of the aluminum foil was dipped in an isopropanol solution containing 0. 9 mol/L of 3,4-ethylenedioxythiophene and 0.1 mol/L of pyrrole (hereinafter referred to as a solution 2), pulled out from the solution, and left at 30° C. for 10 minutes to promote an oxidation polymerization. The procedures of dipping in the solution 1, dipping in the solution 2, and the oxidation polymerization were repeated20 times. The resultant was washed with 50° C. water for 10 minutes and dried at 100° C. for 30 minutes, to thereby coat the dielectric film with a π-conjugated copolymer composition.

Then, a carbon paste and a silver paste were applied to the part of the etched and formed aluminum foil on which the π-conjugated copolymer composition was formed, and three etched and formed aluminum foils prepared in this manner were stacked and a cathode lead terminal was connected thereto. An anode lead terminal was connected by welding to the portion on which the π-conjugated copolymer was not formed. Further, the obtained device was sealed with an epoxy resin, and aged at 125° C. for 2 hours while applying a rated voltage. 30capacitors were produced in this manner.

The initial performances of the 30 capacitors were evaluated by measuring capacitance and loss factor (tan δ) at 120 Hz, impedance at resonance frequency, and leakage current. The leakage current was measured 1 minute after the rated voltage was applied. The measurement results were as follows:

| Capacitance (average) | 108 | μF |
|---|---|---|
| tanδ (average) | 1.2% | |
| Impedance (average) | 10 | mΩ |
| Leakage current (average) | 0.09 | μA |

When a capacitor having a leakage current of 1. 0 μA (0.005 CV) or more was considered as defective, the defective ratio was 0%.

Further, results of a reflow test and a humidity test subsequently carried out are shown below. In the reflow test (or a soldering heat resistance test), evaluation was made such that 30 capacitor devices were prepared and placed under a temperature of 250° C. over 10 seconds three times, the leakage currents of each device was measured 1 minute after applying a rated voltage, and a device with a leakage current of 8.0 μA (0.04 CV) or more was considered as defective. In the humidity test, the devices were left for 500 hours under a high-temperature high-humidity condition of 85° C. and 85% RH, and a device having a leakage current of 60 μA (0.3 CV) or more measured 1 minute after applying a rated voltage was considered as defective.
Leakage current after reflow test: 0.20 μA
Leakage current after humidity test: 11.7 μA
The defective ratios were 0% in both the tests.

### EXAMPLE 6

### 3, 4-Ethylenedioxythiophene:Pyrrole=7:3+Compound Containing Counter Anion with Dopability

1.91 g of ammonium persulfate and 0.40 g of sodium 2-anthraquinone sulfonate were added into a 30 ml three-neck round bottom flask, 5.6 ml of water was added thereto, and the resulting solution was cooled to 0° C. while stirring in an ice bath. A sample tube was prepared, 0.09 g of pyrrole and 0.42 g of 3,4-ethylenedioxythiophene were weighed and charged into the tube, 1.4 ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured to obtain 0.62 g of a copolymer. Then, the copolymer was formed by a forming apparatus into a pellet having a radius of 1 cm. The surface resistance of the pellet was measured by a four-probe method using Loresta IPMCP-250 (produced by Mitsubishi Petrochemical Co., Ltd.). The resistance value was converted into an electric conductivity by multiplying the value by film thickness of the pellet, and the obtained electric conductivity value was 38.3 S/cm.

### EXAMPLE 7

### 3,4-Ethylenedioxythiophene:Pyrrole=9:1+Compound Containing Counter Anion with Dopability

1.70 g of ammonium persulfate and 0.48 g of disodium 2,7-anthraquinone disulfonate (2,7-SAQS) were added into a 30 ml three-neck round bottom flask, 5.0 ml of water was added thereto, and the resulting solution was cooled to 0° C. while stirring in an ice bath. A sample tube was prepared, 0.03 g of pyrrole and 0.48 g of 3,4-ethylenedioxythiophene were weighed and charged into the tube, 1.3 ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0.17 g of a copolymer. Then, the copolymer was formed by a forming apparatus into a pellet having a radius of 1 cm. The surface resistance of the pellet was measured by a four-probe method using Loresta IP MCP-250 (produced by Mitsubishi Petrochemical Co., Ltd.). The resistance value was converted into an electric conductivity by multiplying the value by film thickness of the pellet, and the obtained electric conductivity value was 6.1 S/cm.

### EXAMPLE 8

### 3,4-Ethylenedioxythiophene:Pyrrole=7:3+Compound Containing Counter Anion with Dopability

1.91 g of ammonium persulfate and 0.40 g of sodium 2-anthraquinone sulfonate were added into a 30 ml three-neck round bottom flask, 5.6 ml of water was added thereto, and the resulting solution was cooled to 0° C. while stirring in an ice bath. A sample tube was prepared, 0.09 g of pyrrole and 0.42 g of 3,4-ethylenedioxythiophene were weighed and charged into the tube, 1.4 ml of isopropyl alcohol was added thereto and stirred to prepare a monomer solution. The monomer solution was added dropwise to the aqueous ammonium persulfate solution cooled at 0° C., and stirred for 10 minutes.

After the 10 minutes of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0.34 g of a copolymer. Then, the copolymer was formed by a forming apparatus into a pellet having a radius of 1 cm. The surface resistance of the pellet was measured by a four-probe method using Loresta IP MCP-250 (produced by Mitsubishi Petrochemical Co., Ltd.). The resistance value was converted into an electric conductivity by multiplying the value by film thickness of the pellet, and the obtained electric conductivity value was 20.3 S/cm.

### EXAMPLE 9

### 3,4-Ethylenedioxythiophene:Pyrrole=7:3+Compound Containing Counter Anion with Dopability

1.91 g of ammonium persulfate and 0.40 g of sodium 2-anthraquinone sulfonate were added into a30 ml three-neck round bottom flask, 5.6 ml of water was added thereto, and the resulting solution was cooled to 0° C. while stirring in an ice bath. A sample tube was prepared, 0.09 g of pyrrole and 0.42 g of 3,4-ethylenedioxythiophene were weighed and charged into the tube, 1.4 ml of isopropyl alcohol was added thereto and stirred to prepare a monomer solution. The monomer solution was added dropwise to the aqueous ammonium persulfate solution cooled at 0° C., and stirred for 30 minutes.

After the 30 minutes of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0.41 g of a copolymer. Then, the copolymer was formed by a forming apparatus into a pellet having a radius of 1 cm. The surface resistance of the pellet was measuredly a four-probe method using Loresta IP MCP-250 (produced by Mitsubishi Petrochemical Co., Ltd.). The resistance value was converted into an electric conductivity by multiplying the value by film thickness of the pellet, and the obtained electric conductivity value was 25.9 S/cm.

### EXAMPLE 10

### 3,4-Ethylenedioxythiophene:Pyrrole=7:3+Compound Containing Counter Anion with Dopability

1.91 g of ammonium persulfate and 0.40 g of sodium 2-anthraquinone sulfonate were added into a 30 ml three-neck round bottom flask, 5.6 ml of water was added thereto, and the resulting solution was cooled to 0° C. while stirring in an ice bath. A sample tube was prepared, 0.09 g of pyrrole and 0.42 g of 3,4-ethylenedioxythiophene were weighed and charged into the tube, 1.4 ml of isopropyl alcohol was added thereto and stirred to prepare a monomer solution. The monomer solution was added dropwise to the aqueous ammonium persulfate solution cooled at 0° C., and stirred for 150 minutes.

After the 150 minutes of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0.63 g of a copolymer. Then, the copolymer was formed by a forming apparatus into a pellet having a radius of 1 cm. The surface resistance of the pellet was measured by a four-probe method using Loresta IP MCP-250 (produced by Mitsubishi Petrochemical Co., Ltd.) The resistance value was converted into an electric conductivity by multiplying the value by film thickness of the pellet, and the obtained electric conductivity value was 32.3 S/cm.

### EXAMPLE

### 3,4-Ethylenedioxythiophene:Pyrrole=7:3+Compound Containing Counter Anion with Dopability

1.91 g of ammonium persulfate and 0.40 g of sodium 2-anthraquinone sulfonate were added into a 30 ml three-neck round bottom flask, 16.8 ml of water was added thereto, and the resulting solution was cooled to 0° C. while stirring in an ice bath. A sample tube was prepared, 0.09 g of pyrrole and 0.42 g of 3,4-ethylenedioxythiophene were weighed and charged into the tube, 4.2 ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to therby obtain 0.41 g of a copolymer. Then, the copolymer was formed by a forming apparatus into a pellet having a radius of 1 cm. The surface resistance of the pellet was measured by a four-probe method using Loresta IP MCP-250 (produced by Mitsubishi Petrochemical Co., Ltd.), and converted into an electric conductivity by multiplying the surface resistance by film thickness of the pellet. As a result, the electric conductivity was 22.9 S/cm.

### EXAMPLE 12

### 3, 4-Ethylenedioxythiophene:Pyrrole=7:3+Compound Containing Counter Anion with Dopability

1.91 g of ammonium persulfate and 0.40 g of sodium 2-anthraquinone sulfonate were added into a 30 ml three-neck round bottom flask, 2.8 ml of water was added thereto, and the resulting solution was cooled to 0° C. while stirring in an ice bath. A sample tube was prepared, 0.09 g of pyrrole and 0.42 g of 3,4-ethylenedioxythiophene were weighed and charged into the tube, 0.7ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured to obtain 0.49 g of a copolymer. Then, the copolymer was formed by a forming apparatus into a pellet having a radius of 1 cm. The surface resistance of the pellet was measured by a four-probe method using Loresta IPMCP-250 (produced by Mitsubishi Petrochemical Co., Ltd.). The resistance value was converted into an electric conductivity by multiplying the value by film thickness of the pellet, and the obtained electric conductivity value was 28.6 S/cm.

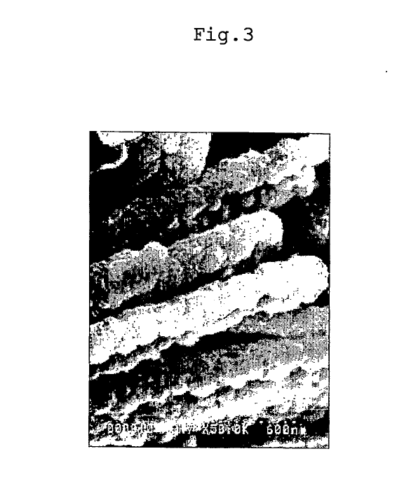

The obtained copolymer was observed by scanning electron microscope (SEM), S-900, manufactured by Hitachi High-Technologies Corporation, at a magnification of 50,000 times and an accelerating voltage of 6 kV. The obtained image is shown in FIG. 3.

### EXAMPLE 13

### 3,4-Ethylenedioxythiophene:Pyrrole=7:3+Compound Containing Counter Anion with Dopability

1.91 g of ammonium persulfate and 0.40 g of sodium 2-anthraquinone sulfonate were added into a 30 ml three-neck round bottom flask, 5. 6 ml of water was added thereto, and the resulting solution was maintained at 40° C. while stirring in an water bath. A sample tube was prepared, 0.09 g of pyrrole and 0.42 g of 3,4-ethylenedioxythiophene were weighed and charged into the tube, 1.4 ml of isopropyl alcohol was added thereto and stirred to prepare a monomer solution. The monomer solution was added dropwise to the aqueous ammonium persulfate solution warmed at 40° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0.63 g of a copolymer. Then, the copolymer was formed by a forming apparatus into a pellet having a radius of 1 cm. The surface resistance of the pellet was measured by a four-probe method using Loresta IP MCP-250 (produced by Mitsubishi Petrochemical Co., Ltd.) The resistance value was converted into an electric conductivity by multiplying the value by film thickness of the pellet, and the obtained electric conductivity value was 5.9 S/cm.

### COMPARATIVE EXAMPLE 1

### 3,4-Ethylenedioxythiophene:Pyrrole=0:10

3.41 g of ammonium persulfate was weighed and charged into a 30 ml three-neck round bottom flask, 9.9 ml of water was added thereto, and the resulting solution was cooled to 0° C. while stirring in an ice bath. A sample tube was prepared, 0.50 g of pyrrole was weighed and charged into the tube, 2.5 ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0.61 g of a polymer. Then, the copolymer was formed by a forming apparatus into a pellet having a radius of 1 cm. The surface resistance of the pellet was measured by a four probe method using Loresta IP MCP-250 (produced by Mitsubishi Petrochemical Co., Ltd.), and converted into an electric conductivity by multiplying the surface resistance by film thickness of the pellet. As a result, the electric conductivity was 0.30 S/cm.

### COMPARATIVE EXAMPLE 2

### 3,4-Ethylenedioxythiophene:Pyrrole=3:7

2.54 g of ammonium persulfate was weighed and charged into a 30 ml three-neck round bottom flask, 7.4 ml of water was added thereto, and the resulting solution was cooled to 0° C. while stirring in an ice bath. A sample tube was prepared, 0.26 g of pyrrole as a reaction accelerator and 0.24 g of 3,4-ethylenedioxythiophene were weighed and charged into the tube, 1.9ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, 100 ml of water was added to the reaction solution and stirred for 1 hour, and the solution was filtrated to remove the water-soluble impurities. Then, 100 ml of acetone was added to the obtained black solid and stirred for 1 hour, to remove the soluble components.

The resultant was dried at 50° C. for 3 hours under reduced pressure and then the mass was measured, to thereby obtain 0. 57 g of a copolymer. Then, the copolymer was formed by a forming apparatus into a pellet having a radius of 1 cm. The surface resistance of the pellet was measured by a four probe method using Loresta IP MCP-250 (produced by Mitsubishi Petrochemical Co., Ltd.). The resistance value was converted into an electric conductivity by multiplying the value by film thickness of the pellet, and the obtained electric conductivity value was 0.53 S/cm.

### COMPARATIVE EXAMPLE 3

### 3,4-Ethylenedioxythiophene:Pyrrole=10:0

1. 61 g of ammonium persulfate was weighed and charged into a 30 ml three-neck round bottom flask, 4.7 ml of water was added thereto, and the resulting solution was cooled to 0° C. while stirring in an ice bath. A sample tube was prepared, 0.50 g of 3,4-ethylenedioxythiophene was weighed and charged into the tube, 1.2 ml of isopropyl alcohol was added thereto and stirred to prepare a monomer solution. The monomer solution was added dropwise to the aqueous ammonium persulfate solution cooled at 0° C., and stirred for 2 hours.

After the 2 hours of stirring, the reaction solution was slightly yellowish and no polymerized product was obtained.

Elemental analysis results of the polymerized products obtained in Example 1 to 13 and Comparative Example 1 to 3 and composition ratios of pyrrole-based compound, thiophene-based compound and dopant are shown in Table 1. The shown percentages of the dopants are ratios to the total of the pyrrole-based compound and the thiophene-based compound.

TABLE 1
polymerization conditions and results

| | | | | Polymerization | Oxidizing agent | | Electric |
|---|---|---|---|---|---|---|---|
| | Charge rate | External | Polymerization | temperature | concentration | Yield | conductivity |
| Examples | EDOT:PY* | dopant | time [min] | [° C.] | [mol/L] | [g] | [S/cm] |
| Example 1 | 9:1 | none | 120 | 0 | 1.5 | 0.26 | 6.8 |
| Example 2 | 7:3 | none | 120 | 0 | 1.5 | 0.49 | 12.1 |
| Example 3 | 5:5 | none | 120 | 0 | 1.5 | 0.53 | 9.4 |
| Example 4 | 9:1 | 2-SAQS** | 120 | 0 | 1.5 | 0.26 | 47 |
| Example 6 | 7:3 | 2-SAQS | 120 | 0 | 1.5 | 0.62 | 38.3 |
| Example 7 | 9:1 | 2,7-SAQS*** | 120 | 0 | 1.5 | 0.17 | 6.1 |
| Example 8 | 7:3 | 2-SAQS | 10 | 0 | 1.5 | 0.34 | 20.3 |
| Example 9 | 7:3 | 2-SAQS | 30 | 0 | 1.5 | 0.41 | 25.9 |
| Example 10 | 7:3 | 2-SAQS | 150 | 0 | 1.5 | 0.63 | 32.3 |
| Example 11 | 7:3 | 2-SAQS | 120 | 0 | 0.5 | 0.41 | 22.9 |
| Example 12 | 7:3 | 2-SAQS | 120 | 0 | 3.0 | 0.49 | 28.6 |
| Example 13 | 7:3 | 2-SAQS | 120 | 40 | 1.5 | 0.63 | 5.9 |
| Comparative | 0:10 | none | 120 | 0 | 1.5 | 0.61 | 0.30 |
| Example 1 | | | | | | | |
| Comparative | 3:7 | none | 120 | 0 | 1.5 | 0.57 | 0.53 |
| Example 2 | | | | | | | |
| Comparative | 10:0 | none | 120 | 0 | 1.5 | 0 | — |
| Example 3 | | | | | | | |

*3,4-Ethylenedioxythiophene:Pyrrole
**Sodium 2-anthraquinone sulfonate
***Disodium 2,7-anthraquinone disulfonate

TABLE 2
Elemental analysis results

| Examples | C [mass %] | H [mass %] | N [mass %] | S [mass %] | EDOT* [%] | Py** [%] | Dopant [%] |
|---|---|---|---|---|---|---|---|
| Example 1 | 42.71 | 3.24 | 2.86 | 18.18 | 69 | 31 | 17 |
| Example 2 | 42.41 | 3.24 | 3.19 | 17.84 | 66 | 34 | 18 |
| Example 3 | 44.07 | 3.29 | 5.12 | 15.25 | 50 | 50 | 15 |
| Example 4 | 45.23 | 3.14 | 1.65 | 18.25 | 85 | 15 | 23 |
| Example 6 | 45.60 | 3.28 | 2.72 | 16.75 | 57 | 43 | 24 |
| Example 7 | 45.73 | 3.51 | 4.98 | 14.49 | 40 | 60 | 25 |
| Example 8 | 46.18 | 3.40 | 5.23 | 14.40 | 25 | 75 | 23 |
| Example 9 | 47.54 | 3.38 | 4.46 | 14.71 | 36 | 64 | 23 |
| Example 10 | 45.90 | 3.25 | 2.75 | 16.67 | 56 | 44 | 25 |
| Example 11 | 49.08 | 3.36 | 4.41 | 14.90 | 41 | 59 | 20 |
| Example 12 | 47.69 | 3.34 | 3.86 | 15.80 | 47 | 53 | 19 |
| Example 13 | 48.94 | 3.20 | 2.61 | 15.28 | 54 | 46 | 36 |
| Comparative | 45.24 | 3.71 | 14.56 | 6.94 | 0 | 100 | 23 |
| Example 1 | | | | | | | |
| Comparative | 45.80 | 3.53 | 9.06 | 10.59 | 24 | 76 | 17 |
| Example 2 | | | | | | | |

*3,4-Ethylenedioxythiophene
**Pyrrole

### EXAMPLE 14

Capacitors were produced and evaluated in the same manner as in Example 5 except that the concentrations of 3,4-ethylenedioxythiophene and pyrrole in an isopropanol solution were 0.95 mol/L and 0.05 mol/L respectively. The results are shown in Table 3 to 5 collectively.

### EXAMPLE 15

Capacitors were produced and evaluated in the same manner as in Example 5 except that the concentrations of 3,4-ethylenedioxythiophene and pyrrole in an isopropanol solution were 0.7 mol/L and 0.3 mol/L respectively. The results are shown in Table 3 to 5 collectively.

### EXAMPLE 16

Capacitors were produced and evaluated in the same manner as in Example 5 except that an oxidation polymerization was performed at 40° C. The results are shown in Table 3 to 5 collectively.

### EXAMPLE 17

Capacitors were produced and evaluated in the same manner as in Example 5 except that an oxidation polymerization was performed at 26° C. and repeated 10 times. The results are shown in Table 3 to 5 collectively.

### EXAMPLE 18

Capacitors were produced and evaluated in the same manner as Example 5except that an oxidation polymerization was performed at 26° C. and repeated 14 times. The results are shown in Table 3 to 5 collectively.

TABLE 3
capacitor producing conditions

| | 3,4-ethylene | | | |
|---|---|---|---|---|
| | dioxy | | Polymerization | Number of times |
| Example | thiophene | Pyrrole | temperature | for performing |
| No. | ratio | ratio | ° C. | polymerization |
| Ex. 5 | 90 | 10 | 30 | 20 |
| Ex. 14 | 95 | 5 | 30 | 20 |
| Ex. 15 | 70 | 30 | 30 | 20 |
| Ex. 16 | 90 | 10 | 40 | 20 |
| Ex. 17 | 90 | 10 | 26 | 10 |
| Ex. 18 | 70 | 30 | 26 | 14 |

TABLE 4
capacitor initial properties

| | Capaci- | Loss | | Leakage | Defective | Number |
|---|---|---|---|---|---|---|
| Example | tance | factor | Impedance | current | ratio | of Short |
| No. | [μF] | [%] | [mΩ] | [μA] | [%] | failure |
| Ex. 5 | 108 | 1.2 | 10 | 0.09 | 0 | 0 |
| Ex. 14 | 107 | 1.3 | 9 | 0.11 | 0 | 0 |
| Ex. 15 | 103 | 2.2 | 23 | 0.16 | 0 | 0 |
| Ex. 16 | 107 | 1.8 | 14 | 0.17 | 0 | 0 |
| Ex. 17 | 98 | 0.9 | 10 | 0.11 | 0 | 0 |
| Ex. 18 | 100 | 1.5 | 22 | 0.14 | 0 | 0 |

TABLE 5
capacitor initial properties

| | Reflow test | | | Humidity test | | |
|---|---|---|---|---|---|---|
| | | Defec- | | | Defec- | |
| | Leakage | tive | Number | Leakage | tive | Number |
| Example | current | ratio | of Short | current | ratio | of Short |
| No. | [μA] | [%] | Failure | [μA] | [%] | Failure |
| Ex. 5 | 0.20 | 0 | 0 | 11.7 | 0 | 0 |
| Ex. 14 | 0.22 | 0 | 0 | 36.7 | 0 | 0 |
| Example 15 | 0.21 | 0 | 0 | 9.8 | 0 | 0 |
| Example 16 | 0.23 | 0 | 0 | 11.2 | 0 | 0 |
| Example 17 | 0.17 | 0 | 0 | 10.2 | 0 | 0 |
| Example 18 | 0.23 | 0 | 0 | 8.9 | 0 | 0 |

### INDUSTRIAL APPLICABILITY

The π-conjugated copolymer of the invention is useful in the electronics field as electrically conductive materials for electrodes, sensors, electronics display devices, photoelectric conversion devices, antistatic materials, etc., optical materials or various electronic components which are required to have high workability.

1. A π-conjugated copolymer comprising a pyrrole-based unit and a thiophene-based unit represented by the general formula (I): 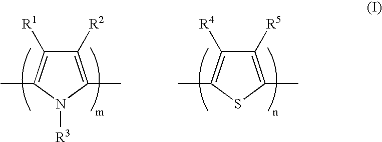
wherein R¹, R², R⁴, and R⁵ independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R¹ and R², and R⁴ and R⁵ may be bonded together at any positions respectively to form at least one 3 to 7-membered, saturated or unsaturated, hydrocarbon ring structure, the ring structure may arbitrarily contain a carbonyl bond, an ether bond, an ester bond, an amide bond, a sulfide bond, a sulfinyl bond, a sulfonyl bond, and an imino bond, the hydrocarbon forming the ring structure may have a group selected from the group consisting of linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R³ represents a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, and m and n represent a composition ratio of the π-conjugated copolymer and satisfy the conditions of m+n=1 and 0<m≦0.75.

2. A π-conjugated copolymer comprising a pyrrole-based unit and a thiophene-based unit represented by the general formula (II), and an electrochemically and/or chemically doped structure: 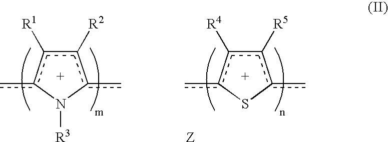
wherein R¹, R², R⁴, and R⁵ independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R¹ and R², and R⁴ and R⁵ may be bonded together at any positions respectively to form at least one 3 to 7-membered, saturated or unsaturated, hydrocarbon ring structure, the ring structure may arbitrarily contain a carbonyl bond, an ether bond, an ester bond, an amide bond, a sulfide bond, a sulfinyl bond, a sulfonyl bond, and an imino bond, the hydrocarbon forming the ring structure may have a group selected from the group consisting of linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, R³ represents a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom, nitro group, cyano group, primary, secondary or tertiary amino group, trihalomethyl group and phenyl group which may have a substituent, m and n represent a composition ratio of the π-conjugated copolymer and satisfy the conditions of m+n=1 and 0<m≦0.75, and Z represents a counter anion with dopability.

3. The π-conjugated copolymer according to claim 1, wherein the pyrrole-based unit is such that R¹ and R² in the general formula (I) independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atoms and cyano group, alternatively R¹ and R² are bonded together at any positions to form a 3 to 7-membered, saturated or unsaturated, hydrocarbon ring structure that may contain an ether bond and/or a sulfonyl bond, and R³ represents a hydrogen atom.

4. The π-conjugated copolymer according to claim 3, wherein the pyrrole-based unit is pyrrole.

5. The π-conjugated copolymer having the electrochemically and/or chemically doped structure according to claim 2, wherein the pyrrole-based unit is such that R¹ and R² in the general formula (II) independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom and a cyano group, alternatively, R¹ and R² are bonded together at any positions to form a 3 to 7-membered, saturated or unsaturated, hydrocarbon ring structure that may contain an ether bond and/or a sulfonyl bond, and R³ represents a hydrogen atom.

6. The π-conjugated copolymer according to claim 5, wherein the pyrrole-based unit is pyrrole.

7. The π-conjugated copolymer according to claim 1, wherein the thiophene-based unit is such that R⁴ and R⁵ in the general formula (I) independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom and cyano group, alternatively, R⁴ and R⁵ are bonded together at any positions to form a 3 to 7-membered, saturated or unsaturated, hydrocarbon ring structure that may contain an ether bond and/or a sulfonyl bond.

8. The π-conjugated copolymer according to claim 7, wherein the thiophene-based unit is 3,4-ethylenedioxythiophene.

9. The π-conjugated copolymer having the electrochemically and/or chemically doped structure according to claim 2, wherein the thiophene-based unit is such that R⁴ and R⁵ in the general formula (II) independently represent a monovalent group selected from the group consisting of hydrogen atom, linear or branched, saturated or unsaturated alkyl group having 1 to 10 carbon atoms, linear or branched, saturated or unsaturated alkoxy group having 1 to 10 carbon atoms, linear or branched, saturated or unsaturated alkyl ester group having 1 to 10 carbon atoms, halogen atom and cyano group, alternatively R⁴ and R⁵ are bonded together at any positions to form a 3 to 7-membered, saturated or unsaturated, hydrocarbon ring structure that may contain an ether bond and/or a sulfonyl bond.

10. The π-conjugated copolymer according to claim 9, wherein the thiophene-based unit is 3,4-ethylenedioxythiophene.

11. The π-conjugated copolymer according to claim 2, having an electric conductivity of 5 S/cm or more.

12. A method for producing a π-conjugated copolymer of claim 1, comprising copolymerizing a pyrrole-based compound represented by the general formula (III): 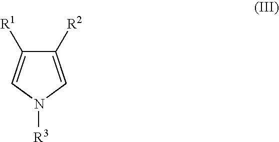
wherein R¹ to R³ have the same meanings as defined in 1 above, and a thiophene-based compound represented by the general formula (IV):
wherein R⁴ and R⁵ have the same meanings as defined in 1 above, by performing chemical oxidative polymerization in the presence of an oxidizing agent at a polymerization temperature 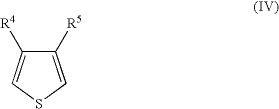
of 60° C. or lower.

13. The method for producing a π-conjugated copolymer according to claim 12, wherein the polymerization is carried out in the presence of a compound containing a counter anion with dopability.

14. The method for producing a π-conjugated copolymer according to claim 12, wherein the pyrrole-based compound is pyrrole.

15. The method for producing a π-conjugated copolymer according to claim 12, wherein the thiophene-based compound is 3,4-ethylenedioxythiophene.

16. The method for producing a π-conjugated copolymer according to claim 12, wherein the oxidizing agent contains an iron salt or a persulfate salt.

17. The method for producing a π-conjugated copolymer according to claim 13, wherein the compound containing a counter anion with dopability is an organic sulfonic acid compound.

18. The method for producing a π-conjugated copolymer according to claim 12, wherein a mixed solvent of isopropanol and water is used in the polymerization.

19. The method for producing a π-conjugated copolymer according to claim 12, wherein the polymerization temperature is 30° C. or lower.

20. An article comprising an oxide film formed by electrolytically oxidizing a valve action metal, wherein the oxide film is coated with the π-conjugated copolymer described in claim 1.

21. The article according to claim 20, wherein the valve action metal comprises at least one metal selected from the group consisting of aluminum, silicon, tantalum, niobium, titanium and zirconium.

22. A solid electrolytic capacitor, comprising as a solid electrolyte the π-conjugated copolymer described in claim 1.

23. A method for producing a solid electrolytic capacitor in which a solid electrolyte layer comprising a π-conjugated copolymer is formed on a dielectric film of porous valve-action metal, which method comprises a step of polymerizing a pyrrole-based compound represented by the general formula (III): 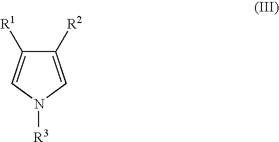
wherein R¹ to R³ have the same meanings as defined in 1 above,
and a thiophene-based compound represented by the general formula (IV) 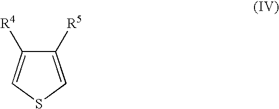
wherein, R⁴ and R⁵ have the same meanings as defined in 1 above,
by using a solution of an oxidizing agent having polymerization-initiating property singly or using a mixed solution of such an oxidizing agent and an electrolyte which contains a counter anion with dopability to form the π-conjugated copolymer on the dielectric film.

24. The method for producing a solid electrolytic capacitor according to claim 23, wherein the polymerization is carried out within a temperature range of −30° C. to 40° C.

25. The method for producing a solid electrolytic capacitor according to claim 23, wherein the polymerization is carried out in the atmosphere of a relative humidity of 5% to 70%.

26. The method for producing a solid electrolytic capacitor according to claim 23, wherein the porous valve action metal contains at least one metal selected from the group consisting of aluminum, silicon, tantalum, niobium, titanium and zirconium.

27. The method for producing a solid electrolytic capacitor according to claim 23, comprising using pyrrole-based compound as represented by the general formula (III): 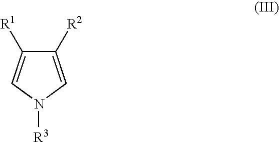
wherein R¹ to R³ have the same meanings as defined in 3 above,
and using thiophene-based compound as represented by the general formula (IV): 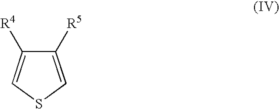
wherein R⁴ and R⁵ have the same meanings as defined in 7 above.

28. The method for producing a solid electrolytic capacitor according to claim 23, wherein the pyrrole-based compound is pyrrole and the thiophene-based compound is 3,4-ethylenedioxythiophene.

29. The method for producing a solid electrolytic capacitor according to claim 23, wherein the oxidizing agent having a polymerization-initiating property contains an iron salt or a persulfate salt.

30. The method for producing a solid electrolytic capacitor according to claim 23, wherein the electrolyte containing a counter anion with dopability contains an organic sulfonic acid compound.

31. The method for producing a solid electrolytic capacitor according to claim 23, wherein the polymerization step is carried out multiple times.

32. The method for producing a solid electrolytic capacitor according to claim 23, wherein the maximum thickness of the solid electrolyte layer formed on the dielectric film is 10 μm to 200 μm.
